(19) United States
(12) Patent Application Publication
(10) Pub. No.: US 2008/0278093 A1
(43) Pub. Date: Nov. 13, 2008

(54) Backlight module with light tubes and liquid crystal display with same

(75) Inventor: Sha Feng, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/152,102

(22) Filed: May 12, 2008

(30) Foreign Application Priority Data
May 11, 2007 (CN) 200710074427.6

(51) Int. Cl. H05B 41/16

(52) U.S. Cl. 315/250

(57) ABSTRACT

An exemplary backlight module (20) includes a plurality of light units (22) disposed in parallel. Each light unit includes two opposite electrodes (221, 222). Two alternating current (AC) voltages having 180° phase difference and a same frequency are respectively applied to the two opposite electrodes, and two AC voltages respectively applied to the two electrodes, at a same side, of two adjacent light units, have 180° phase difference and a same frequency.

### FIELD OF THE INVENTION

The present invention relates to backlight modules such as those used in liquid crystal displays (LCDs), and more particularly to a backlight module having a smaller leakage current and uniform light beams output.

### GENERAL BACKGROUND

Liquid crystal displays are commonly used as displays for compact electronic apparatuses, because they not only provide good quality images with little power but are also very thin. The liquid crystal in a liquid crystal display does not emit any light itself. The liquid crystal has to be lit by a light source so as to clearly and sharply display text and images. Thus, a backlight module is generally needed for a liquid crystal display.

Referring to FIG. 5 and FIG. 6, a typical backlight module 10 is disclosed, which has a single-side power supply. The backlight module 10 has a reflector 11, a plurality of light units 12, a diffuser 13, and a bright enhancement film (BEF) 14, which are arranged in that order from bottom to top. The light tubes 12 are located adjacent to a light incident surface (not labeled) of the diffuser 13 in parallel, and are linear cold cathode fluorescent lamps (CCFLs) fro emitting light beams. Each light tube 12 includes a first electrode 121, and a second electrode 122 opposite to the first electrode 121. A part of light beams directly transmits through the diffuser 13 and the BEF 14 to attain a uniform surface light over a screen. Another part of light beams is reflected by the reflector 11 to the diffuser 13 and the BEF 14, and then transmits through the diffuser 13 and the BEF 14 until emits out.

The light tubes 12 are electrically connected with an external power supply at a single side, that is, the first electrodes 121 are electrically connected with a transformer 17 which provides high voltage electricity to the first electrodes 121. The first electrodes 121 are aligned parallel to each other. The second electrodes 122 of the light tubes 12 are grounded. The second electrodes 122 are aligned parallel to each other.

However, in the typical backlight module 10 above, it is necessary to dispose the single-side power supply in the vicinity of the first electrodes 121, i.e. hot-side terminals, power-supply terminals or high-voltage terminals. Therefore, the temperature is elevated to the side of the first electrodes 121 due to heat generation from the single-side power supply. Such temperature difference between the first and the second electrodes 121, 122 of the CCFL light tubes 12 causes mercury to concentrate in the lower-temperature portion and then sputtering occurs at mercury-lacking terminals, which shortens the life of lamps.

In addition, a house (not shown) is generally provided for receiving the backlight module 10, which is made of metal, e.g. aluminum or its alloy; since such a high voltage is applied to the light tubes 12 as mentioned above, a plurality of parasitic capacitances is formed in the space between the house and the CCFL lamps 12 and the lines connecting from single-side power supply to the CCFL lamps 12. When the plurality of parasitic capacitances causes leakage current, then, a tube current near the second electrodes 122 becomes lower by the leakage current than a tube current near the first electrodes 121. This causes large difference in brightness particularly in the left-to-right direction on the screen.

What is needed, therefore, is a backlight module that can overcome the above-described deficiencies. What is also needed is a liquid crystal display employing such a backlight module.

### SUMMARY

In one preferred embodiment, an exemplary backlight module includes a plurality of light units disposed in parallel. Each light unit includes two opposite electrodes. Two alternating current (AC) voltages having 180° phase difference and a same frequency are respectively applied to the two opposite electrodes, and two AC voltages respectively applied to the two electrodes, at a same side, of two adjacent light units, have 180° phase difference and a same frequency.

In another preferred embodiment, an exemplary liquid crystal display includes a liquid crystal panel; and a backlight module located adjacent to the liquid crystal panel. The backlight module includes a plurality of light units disposed in parallel. Each light unit includes two opposite electrodes. Two alternating current (AC) voltages having 180° phase difference and a same frequency are respectively applied to the two opposite electrodes, and two AC voltages respectively applied to the two electrodes, at a same side, of two adjacent light units, have 180° phase difference and a same frequency.

Other aspects, advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the described embodiments. In the drawings, like reference numerals designate corresponding parts throughout various views, and all the views are schematic.

FIG. 1 is a side view of a backlight module according to a first embodiment of the present invention, which has a plurality of light units.

FIG. 2 is a block diagram showing components and circuitry of the backlight module of FIG. 1.

FIG. 3 is an equivalent circuit diagram of parasitic capacitances between two adjacent light units.

FIG. 4 is side view of a liquid crystal display having the backlight module of FIG. 1, according to a second embodiment of the present invention.

FIG. 5 is a side view of a typical backlight module.

FIG. 6 is a block diagram showing components and circuitry of the backlight module of FIG. 5.

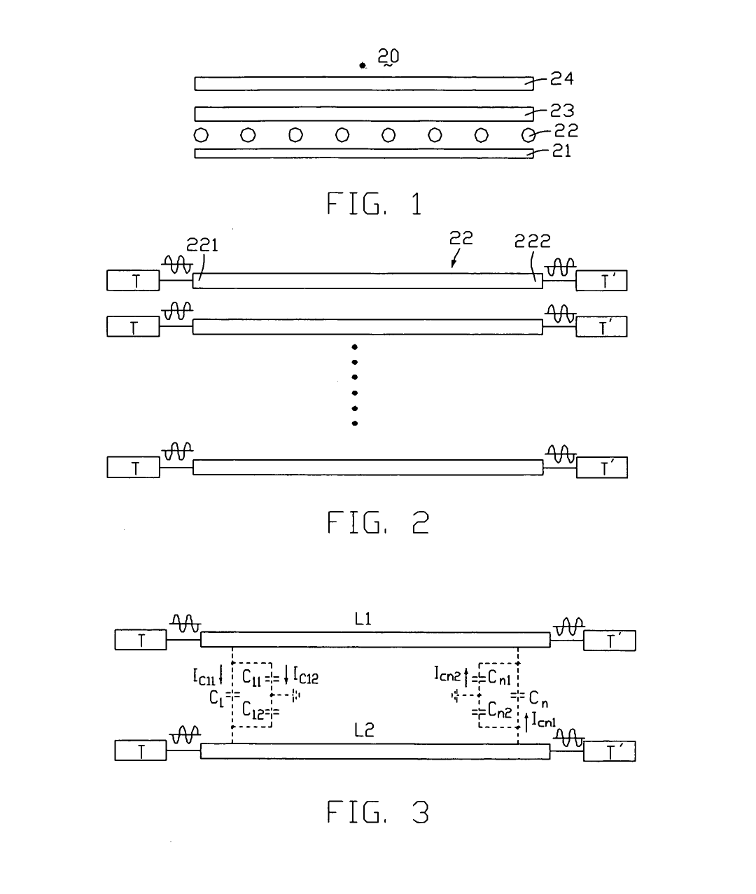

### DETAILED DESCRIPTION OF PREFERRED EMBODIMENTS

Reference will now be made to the drawings to describe the preferred embodiments in detail.

Referring to FIG. 1, a backlight module 20 according to a first embodiment of the present invention is shown. The backlight module 20 includes a reflector 21, a plurality of light tubes 22, a diffuser 23, and a BEF 24, which are arranged together in that order, from bottom to top.

The light tubes 22 are located between the diffuser 23 and the reflector 21 in parallel, and are linear cold cathode fluorescent lamps (CCFLs) for emitting light beams. Each light tube 22 includes a first electrode 221, and a second electrode 222 opposite to the first electrode 221. A part of light beams directly sequentially transmit through the diffuser 23 for scattering light beams, and the BEF 24 for converging light beams toward a predetermined direction, and finally attaining a uniform light beams output over the whole emitting surface of the BEF 24. Another part of light beams transmits downward to the reflector 21, and then is reflected back to the diffuser 23 and the BEF 24 too.

The light tubes 22 are electrically connected with external power supplies. The first electrodes 221 are electrically connected with a transformer T, which respectively provides an AC high voltage electricity to the first electrodes 221. The first electrodes 221 are aligned parallel to each other. The second electrodes 222 of the light tubes 22 are electrically connected with a second transformer T′, which also respectively provides an AC high voltage electricity to the second electrodes 222. The second electrodes 222 are aligned parallel to each other. Each of the first and the second transformers T, T′ respectively applies AC voltages with a 180° phase difference and a same frequency to two adjacent light tubes 22. In addition, the first and the second electrodes 221, 222 of each light unit 22 are respectively applied an AC voltage with a 180° phase difference and a same frequency. That is, the two first electrodes 221 of the two adjacent light tubes 22 are respectively applied AC voltages with a 180° phase difference and a same frequency provided by the first transformer T, and the two second electrodes 222 of the two adjacent light tubes 22 are respectively applied AC voltages with a 180° phase difference and a same frequency provided by the second transformer T′. In addition, the AC voltages applied to the first and the second electrodes 221, 222 of each light tube 22 have 180° phase difference and a same frequency.

FIG. 3 is an equivalent circuit diagram of parasitic capacitances between two adjacent light tubes. When the backlight module 20 is in a working state, a house (not shown) is generally provided for receiving the backlight module 20, which is made of metal, e.g. aluminum or its alloy and is grounded. Take two adjacent light tubes L1, L2 for example, since such two AC high voltages having 180° phase difference respectively applied to the first or the second electrodes 221, 222 of the two adjacent light tubes L1, L2 as mentioned above, a plurality of parasitic capacitances is formed, which are a plurality of parasitic capacitances C1 to Cn between two adjacent light tubes L1, L2, and a plurality of parasitic capacitances C11, C12 to Cn1, Cn2 respectively formed between the grounded house and the two adjacent light tubes L1, L2. When voltages are applied to the two adjacent light units L1, L2, at a side of the first electrodes of the light units L1, L2, a first current I_{C11} is produced, which flows from the first electrode 221 of the first light unit L1 to the first electrode 221 of the second light unit L2. Thus, a leakage current I_{C12} from the first electrodes 221 of the first light unit L1 and the second light unit L2 to ground through the parasitic capacitances C11, C12 is decreased. At the same time, the current I_{C11} supplies a current compensation to the first electrode 221 of the second light unit L2. Same to a side of the second electrodes 222 of the light units L1, L2, a first current I_{Cn1} is produced, which flows from the second electrode 222 of the second light unit L2 to the second electrode 222 of the first light unit L1. Thus, a leakage current I_{Cn2} from the second electrodes 222 of the first light unit L1 and the second light unit L2 to ground through the parasitic capacitances Cn1, Cn2 is decreased. At the same time, the current I_{Cn1} supplies a current compensation to the second electrode 222 of the first light unit L2. Thus, the luminance of the light units 22 and the power supply utilization ratio is improved because the leakage current is decrease. In addition, the currents flow in the first light unit L1 and the second light unit L2 keep substantially equally at the first and second electrodes 221, 222. Therefore, the backlight module 20 can attain a uniform light beams output over the whole emitting surface thereof.

Comparing to the typical backlight module 10, the backlight unit 20 utilizes applying AC high voltages having 180° phase difference and a same frequency applied to the two electrodes at a same side of the two adjacent light tubes 22 to attain a uniform light beams output over the whole emitting surface thereof. In addition, the backlight unit 20 utilizes applying AC high voltages having 180° phase difference and a same frequency to the two opposite electrodes of one light tube 22 to decrease the leakage current, which improves the luminance of the light unit 22 and the power supply utilization ratio.

In an alternative embodiment, the backlight module 20 can utilize a plurality of transformers T, T′ to provide a plurality of power supplies to the plurality of light units 22, respectively. In addition, the AC voltages applied to the two adjacent light units 22 having 180° phase difference and a same frequency can have a same amplitude or two different amplitudes. Take the same amplitude for example, the backlight module 20 allows the voltages applied to the two opposite electrodes (e.g. the first electrode 221 or the second electrode 222) to be about half that of the typical single-side power supply. Thus, no temperature difference is produced because no voltage difference between the two opposite electrodes 221, 222. Since no temperature difference is caused between the two electrodes 221, 222, it is possible to alleviate the conventional problem that concentration of mercury in the lower-temperature portion causes sputtering at mercury-lacking electrodes to shorten lamp's lifetime. The light unit's lifetime can thus be lengthened. Furthermore, when the light units 22 and the light units 12 have the same full length, for example, the plurality of parasitic capacitances C11, C12 to Cn1, Cn2 formed between the grounded house and the two adjacent light tubes 22 is the same as the parasitic capacitances occurring in the typical backlight module 10. However, voltages fed from the external power supply are approximately halved, comparing to the typical backlight module 10, and therefore leakage current caused by the parasitic capacitances C11, C12 to Cn1, Cn2 is halved. Thus, the luminance of the light unit 22 and the power supply utilization ratio is further improved.

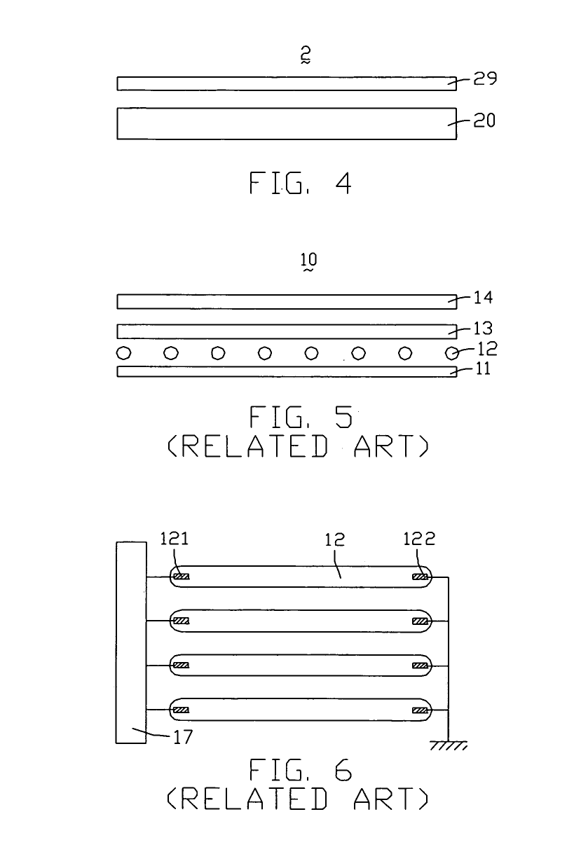

Referring also to FIG. 4, a liquid crystal display 2 according to an exemplary embodiment of the present invention is shown. The liquid crystal display 2 includes a liquid crystal panel 29, and the backlight module 20 located adjacent to the liquid crystal panel 29.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module comprising:
a plurality of light units disposed in parallel, which each comprise two opposite electrodes, wherein two alternating current (AC) voltages having 180° phase difference and a same frequency are respectively applied to the two opposite electrodes, and two AC voltages respectively applied to the two electrodes, at a same side, of two adjacent light units, have 180° phase difference and a same frequency.

2. The backlight module in claim 1, further comprising at least two transformers, the two opposite electrodes being respectively electrically connected to two transformers.

3. The backlight module in claim 1, further comprising a diffuser, disposed adjacent to the light units.

4. The backlight module in claim 3, further comprising a reflector, the light units being disposed between the reflector and the diffuser.

5. The backlight module in claim 1, wherein the light units are cold cathode fluorescent lamps.

6. The backlight module in claim 1, wherein the two AC voltages having 180° phase difference and a same frequency have a same amplitude.

7. The backlight module in claim 1, wherein the two AC voltages having 180° phase difference and a same frequency have two different amplitudes.

8. A liquid crystal display comprising:
a liquid crystal panel; and
a backlight module located adjacent to the liquid crystal panel, the backlight module comprising:
a plurality of light units disposed in parallel, which each comprise two opposite electrodes, wherein two alternating current (AC) voltages having 180° phase difference and a same frequency are respectively applied to the two opposite electrodes, and two AC voltages respectively applied to the two electrodes, at a same side, of two adjacent light units, have 180° phase difference and a same frequency.

9. The liquid crystal display in claim 8, further comprising at least two transformers, the two opposite electrodes being respectively electrically connected to two transformers.

10. The liquid crystal display in claim 8, further comprising a diffuser, disposed adjacent to the light units.

11. The liquid crystal display in claim 10, further comprising a reflector, the light units being disposed between the reflector and the diffuser.

12. The liquid crystal display in claim 8, wherein the light units are cold cathode fluorescent lamps.

13. The liquid crystal display in claim 8, wherein the two AC voltages having 180 degrees phase difference and a same frequency have a same amplitude.

14. The liquid crystal display in claim 8, wherein the two AC voltages having 180 degrees phase difference and a same frequency have two different amplitudes.
